(19) United States
(12) Patent Application Publication
(10) Pub. No.: US 2023/0156119 A1
(43) Pub. Date: May 18, 2023

(54) TELEPHONE COMMUNICATION SYSTEM, TELEPHONE COMMUNICATION METHOD, SETTING SERVER AND SETTING PROGRAM

(71) Applicant: Nippon Telegraph and Telephone Corporation, Tokyo (JP)

(72) Inventor: Haruka EITOKU, Musashino-shi, Tokyo (JP)

(21) Appl. No.: 17/802,367

(22) PCT Filed: Feb. 28, 2020
(86) PCT No.: PCT/JP2020/008238

§ 371 Date: Aug. 25, 2022

(51) Int. Cl. H04M 3/42; H04M 15/12

(52) U.S. Cl. CPC H04M 3/42017; H04M 15/12

(57) ABSTRACT

A call system 5 includes a setup server 1 provided on a communication network which controls communication between a calling terminal 2 and a called terminal 3 and a charging server 4 which charges the calling terminal 2. The setup server 1 includes a setup unit 21 which sets advertisement-related CAT media in a signal addressed to the calling terminal 2 during a call between the calling terminal 2 and the called terminal 3 and a measurement unit 22 which measures a start time and an end time of the setting of the CAT media in the signal addressed to the calling terminal 2. The calling terminal 2 includes a play unit which plays the CAT media. The charging server 4 includes a charge unit which charges the calling terminal 2 on the basis of the measured times.

### TECHNICAL FIELD

The present invention relates to a call system, a call method, a setup server, and a setup program.

### BACKGROUND ART

Along with recent popularization of smartphones and the like, forms of calls have been becoming diversified. For example, a user can talk on a videophone while viewing a face of a person on the other end of the line and can view another video while having an audio chat with the person on the other end of the line.

For example, in 3GPP (3rd Generation Partnership Project), a mechanism for continuously streaming CAT (Customized Alerting Tone) media, such as video media or audio media, using a CAT, before a start of a call and during startup of the call is under consideration, and the specifications of the mechanism are becoming finalized (see Non-Patent Literature 1). A mechanism for continuously streaming video media or audio media after an end of a call using a CAT is also under consideration.

CAT media is provided by an AS/MRF (Application Server/Multimedia Resource Function) of a calling IMS (IP Multimedia Subsystem) network to which a calling terminal belongs or a called IMS network to which a called terminal belongs.

### CITATION LIST

### Non-Patent Literature

Non-Patent Literature 1: 3GPP “Video enhancement of IMS CAT/CRS/announcement services,” 3GPP TSG-CT WG1 Meeting #121 Reno (Nev.), USA, 11-15 Nov. 2019, C1-199059

### SUMMARY OF THE INVENTION

### Technical Problem

The idea of causing viewing of advertisement-related CAT media on a calling terminal without affecting a call between the calling terminal and a called terminal and giving a discount on the call or the like for the calling terminal is conceivable. However, there is no specific method for implementing the idea.

The present invention has been made in view of the above-described circumstances. An object of the present invention is to provide a technique for streaming an advertisement using CAT media and providing feedback to a calling terminal.

### Means for Solving the Problem

A call system according to one aspect of the present invention includes a setup server provided on a communication network which controls communication between a calling terminal and a called terminal and a charging server which charges the calling terminal, the setup server includes a setup unit which sets advertisement-related CAT media in a signal addressed to the calling terminal during a call between the calling terminal and the called terminal, and a measurement unit which measures a start time and an end time of the setting of the CAT media in the signal addressed to the calling terminal, the calling terminal includes a play unit which plays the CAT media, and the charging server includes a charge unit which charges the calling terminal on the basis of the measured times.

A call method according to one aspect of the present invention is used in a call system including a setup server provided on a communication network which controls communication between a calling terminal and a called terminal and a charging server which charges the calling terminal and includes setting, by the setup server, advertisement-related CAT media in a signal addressed to the calling terminal during a call between the calling terminal and the called terminal, playing, by the calling terminal, the CAT media, measuring, by the setup server, a start time and an end time of the setting of the CAT media in the signal addressed to the calling terminal, and charging, by the charging server, the calling terminal on the basis of the measured times.

A setup server according to one aspect of the present invention includes a setup unit which sets advertisement-related CAT media in a signal addressed to a calling terminal during a call between the calling terminal and a called terminal, and a measurement unit which measures a start time and an end time of the setting of the CAT media in the signal addressed to the calling terminal.

One aspect of the present invention is a setup program for causing a computer to function as the above-described setup servers.

### Effects of the Invention

According to the present invention, it is possible to provide a technique for streaming an advertisement using CAT media and providing feedback to a calling terminal.

### BRIEF DESCRIPTION OF DRAWINGS

FIG. 1 is a diagram for explaining a system configuration of a call system according to an embodiment of the present invention.

FIG. 2 is a block diagram for explaining functions of a setup server according to the embodiment of the present invention.

FIG. 3 is a flowchart for explaining a setup process by a setup unit of the setup server according to the embodiment of the present invention.

FIG. 4 is a sequence chart for explaining a process during call connection in the call system according to the embodiment of the present invention.

FIG. 5 is a sequence chart for explaining a process during a call in the call system according to the embodiment of the present invention.

FIG. 6 is a sequence chart for explaining a process after a call in the call system according to the embodiment of the present invention.

FIG. 7 is a diagram for explaining a system configuration of a call system according to a modification.

FIG. 8 is a diagram for explaining a hardware configuration of a computer used for the setup server.

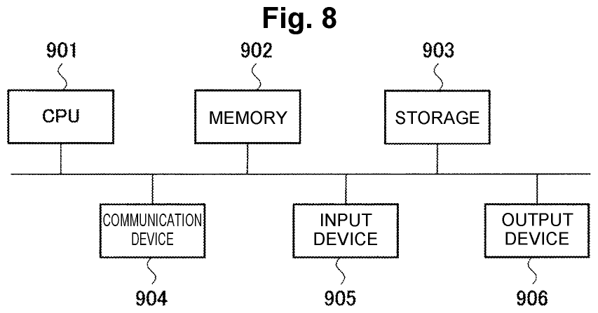

### DESCRIPTION OF EMBODIMENTS

An embodiment of the present invention will be described below with reference to the drawings. Same portions in the drawings are denoted by same reference numerals, and a description thereof will be omitted.

(Communication System)

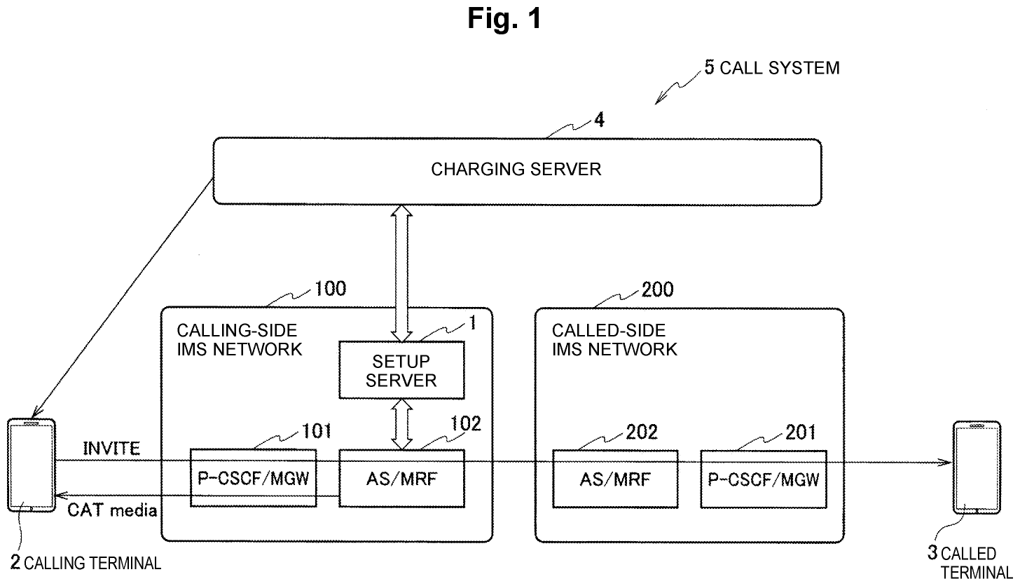

A call system 5 according to the embodiment of the present invention will be described with reference to FIG. 1. The call system 5 includes a setup server 1, a calling terminal 2, a called terminal 3, a charging server 4, a calling-side IMS network 100, and a called-side IMS network 200.

The setup server 1 sets advertisement-related CAT media in a signal addressed to the calling terminal 2. More specifically, the setup server 1 causes a MRF function to set the advertisement-related CAT media.

The setup server 1 also measures a start time and an end time of setting of CAT media. More specifically, the setup server 1 causes an AS/MRF function unit 102 or a P-CSCF/MGW function unit 101 to measure a start time and an end time of passage of a signal with the CAT media set therein. The setup server 1 calculates a time period during which an advertisement is viewed from the start time and the end time and transmits the calculated time period to the charging server 4. The setup server 1 is provided on a communication network which controls communication between the calling terminal 2 and the called terminal 3.

In the embodiment of the present invention, the setup server 1 is provided on the calling-side IMS network 100. The setup server 1 sets CAT media in a signal addressed to the calling terminal 2 and measures a start time and an end time of the setting of the CAT media, in collaboration with the P-CSCF/MGW function unit 101 and the AS/MRF function unit 102 of the calling-side IMS network 100.

The calling terminal 2 and the called terminal 3 are terminals capable of calling and playing CAT media in accordance with the standards of 3GPP. The calling terminal 2 and the called terminal 3 are so-called smartphones.

The calling terminal 2 has a call unit which makes a call to the called terminal 3 and a play unit which plays CAT media provided from the calling-side IMS network 100.

The charging server 4 charges the calling terminal 2 for a call originated by the calling terminal 2. The charging server 4 includes a charge unit which charges a user of the calling terminal 2 on the basis of an advertisement viewing time period in the calling terminal 2 which is measured by the setup server 1. The charging server 4, for example, provides feedback, such as a discount on a fee for a call based on the advertisement viewing time period, to the calling terminal 2.

The calling terminal 2 is charged a fee for a call such that a discount on the fee for the call increases when an advertisement is viewed for a long time period in the calling terminal 2. For example, an amount charged to a calling terminal which plays an advertisement only during call connection is smaller than an amount charged to a calling terminal which plays an advertisement from during connection of a call to an end of the call.

The calling-side IMS network 100 is a communication network which accommodates the calling terminal 2. The called-side IMS network 200 is a communication network which accommodates the called terminal 3. The calling-side IMS network 100 and the called-side IMS network 200 are each a network which provides multimedia using IP (Internet Protocol). In the embodiment of the present invention, the calling-side IMS network 100 and the called-side IMS network 200, in particular, provide a call between the calling terminal 2 and the called terminal 3 and provide advertisement-related CAT media to the calling terminal 2.

The calling-side IMS network 100 provides the P-CSCF/MGW (Proxy Call Session Control Function/Media GateWay) function unit 101 and the AS/MRF function unit 102. A P-CSCF function is a SIP proxy and receives contact from the calling terminal 2. A MGW function has a user plane of a circuit switched network, i.e., a function of interfacing with sound or the like which is user data and performs conversion between RTP (Real-time Transport Protocol) and PCM (Pulse Code Modulation). An AS function hosts and executes a service provided by the call system 5. A MRF function provides a function, such as media playing.

The called-side IMS network 200 similarly provides a P-CSCF/MGW function unit 201 and an AS/MRF function unit 202. A P-CSCF function, a MGW function, an AS function, and a MRF function are the same as the functions of the calling-side IMS network.

Functions other than the P-CSCF/MGW functions and the AS/MRF functions are omitted from each of the calling-side IMS network 100 and the called-side IMS network 200 shown in FIG. 1.

Note that the functions of each of the calling-side IMS network 100 and the called-side IMS network 200 are implemented by one or more computers. In the embodiment of the present invention, the setup server 1 is described as being composed of hardware different from the AS/MRF function unit 102. However, functions of the setup server 1 may be implemented in the AS/MRF function unit 102 or may be implemented in the P-CSCF/MGW function unit 101.

(Setup Server)

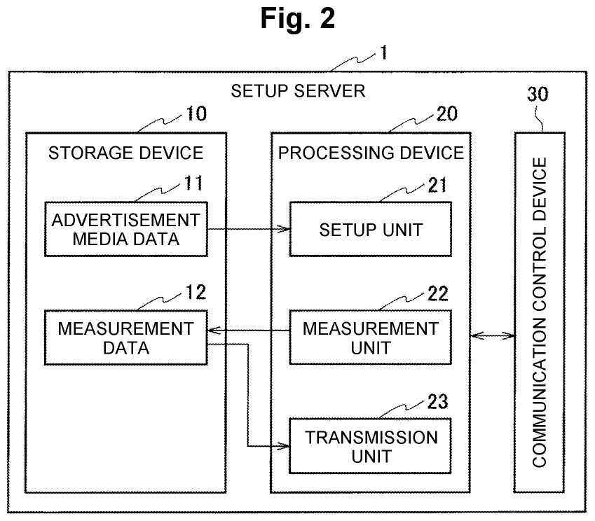

The setup server 1 will be described with reference to FIG. 2. The setup server 1 is a general computer including a storage device 10, a processing device 20, and a communication control device 30. The general computer executes a setup program which implements a predetermined function, thereby implementing the functions shown in FIG. 2.

The storage device 10 stores the setup program and also stores advertisement media data 11 and measurement data 12.

The advertisement media data 11 is advertising video data which is provided to the calling terminal 2. The advertisement media data 11 may be a collection of pieces of advertisement media. The advertisement media data 11 is provided as CAT media or CAT early media to the calling terminal 2. Alternatively, the advertisement media data 11 may be characters in text form.

The advertisement media data 11 may include both types with and without sound. For example, video data with sound is provided to the calling terminal 2 at a time having no effect on a call between the calling terminal 2 and the called terminal 3, such as during call connection or after the call. During a call between the calling terminal 2 and the called terminal 3, soundless video data is provided to the calling terminal 2 so as not to interfere with the call.

The phrase “during call connection” here refers to a state during a call from when the calling terminal 2 originates a call to when the call is accepted in the called terminal 3. The phrase “after a call” refers to a state where a call is disconnected by the called terminal 3 but is not disconnected by the calling terminal 2. The phrase “during a call” refers to a state where the called terminal 3 has received a call after origination by the calling terminal 2, and the call is going on between the calling terminal 2 and the called terminal 3.

The measurement data 12 identifies a time period during which advertising CAT media is provided to the calling terminal 2. For example, the measurement data 12 may be associated with a start time and an end time of provision of advertising CAT media to the calling terminal 2 or may be associated with a provision time period identified by the start time and the end time. The measurement data 12 may double as log data.

The processing device 20 includes a setup unit 21, a measurement unit 22, and a transmission unit 23.

The setup unit 21 sets advertisement-related CAT media in a signal addressed to the calling terminal 2 during a call between the calling terminal 2 and the called terminal 3. The setup unit 21 also sets advertisement-related CAT early media in a signal addressed to the calling terminal 2 during connection of a call from the calling terminal 2 to the called terminal 3.

As to a call between the calling terminal 2 and the called terminal 3, in a state where the called terminal 3 has disconnected the call but the calling terminal 2 has not disconnected the call, the setup unit 21 sets CAT media in a signal addressed to the calling terminal 2. Specifically, when the setup unit 21 senses that the called terminal 3 has disconnected the call and that the calling terminal 2 has not disconnected the call, the setup unit 21 causes the AS/MRF function unit 102 to transmit a re-INVITE message to the calling terminal 2. After reception of a 2000K message in response to the re-INVITE message transmitted to the calling terminal 2 by the AS/MRF function unit 102, the setup unit 21 sets advertisement-related CAT media in a signal addressed to the calling terminal 2.

Note that the setup unit 21 performs control so as to provide advertisement-related CAT media under conditions permitted in advance by the calling terminal 2, such as during call connection, during a call, and after a call. For example, if the calling terminal 2 permits provision of advertisement-related CAT media during a call and does not permit provision of advertisement-related CAT media during call connection or after a call, the setup unit 21 provides advertisement-related CAT media to the calling terminal 2 during a call and does not provide CAT media during call connection or after a call.

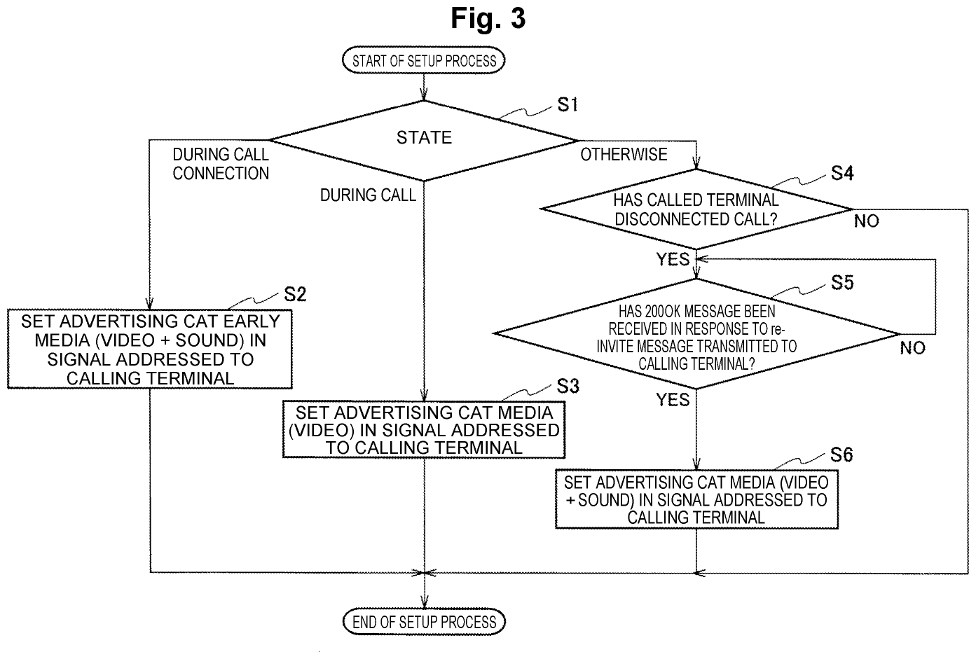

A setup process by the setup unit 21 will be described with reference to FIG. 3. First, in step S1, the process branches to a different point depending to a state of the calling terminal 2.

If the calling terminal 2 is in a state during call connection, the setup unit 21 sets advertisement-related CAT early media in a signal addressed to the calling terminal 2 in step S2 and ends the process. The CAT early media is preferably composed only of a video so as not to interfere with a ringing tone.

If the calling terminal 2 is in a state during a call, the setup unit 21 sets advertisement-related CAT media in a signal addressed to the calling terminal 2 in step S3 and ends the process. The CAT media is preferably composed only of a video so as not to interfere with the call. Even if the call uses video in the case of, e.g., a videophone call, a play unit for advertisement-related CAT media may be provided outside a frame of a video display unit for a videophone call or a semitransparent CAT media play unit may be provided at the video display unit for a videophone call.

In step S4, if the called terminal 3 has disconnected the call, and the calling terminal 2 has not disconnected the call, the setup unit 21 advances to step S5. In the other cases, the setup unit 21 ends the process.

If the called terminal 3 has disconnected the call, and the calling terminal 2 has not disconnected the call, the setup unit 21 transmits, to the AS/MRF function unit 102, a command to transmit a re-INVITE message to the calling terminal 2. The setup unit 21 waits to receive a 200OK message in response to the re-INVITE message transmitted to the calling terminal 2. When the setup unit 21 receives a 200OK message in step S5, the setup unit 21 advances to step S6. In step S6, the setup unit 21 sets advertisement-related CAT media in a signal addressed to the calling terminal 2 and ends the process. The CAT media may be composed only of a video or may include a sound as long as the sound does not interfere with a disconnection tone in the called terminal 3.

During a call, the measurement unit 22 measures a start time and an end time of setting of CAT media in a signal addressed to the calling terminal 2 and records the measured times in the measurement data 12. During call connection, the measurement unit 22 measures a start time and an end time of setting of CAT early media in a signal addressed to the calling terminal 2 and records the measured times in the measurement data 12. Even if a call is disconnected by the called terminal 3, the measurement unit 22 measures a start time and an end time of setting of CAT media in a signal addressed to the calling terminal 2 and records the measured times in the measurement data 12.

The measurement unit 22, for example, senses a signal or a process transmitted or received by the P-CSCF/MGW function unit 101 or the AS/MRF function unit 102 and measures a time of setting of CAT media or a time of deletion of the CAT media.

When an instruction to stop playing CAT media or CAT early media is input in the calling terminal 2, the measurement unit 22 measures an end time. In the calling terminal 2, the play unit where CAT media or CAT early media is played is provided, and a button for stopping media playing is provided on the play unit. When the button is pressed in the calling terminal 2, the calling-side IMS network 100 is notified of the fact that the button is pressed, and the setup server 1 knows that an instruction to stop media playing is input in the calling terminal 2. At that time, the setup server 1 measures an end time.

The transmission unit 23 transmits the measurement data 12 to the charging server 4. For example, a protocol, such as SIP (Session Initiation Protocol) or HTTP (Hypertext Transfer Protocol), is used. The transmission unit 23 transmits the measurement data 12 to the charging server 4 at a time when feedback about viewing of an advertisement in the calling terminal 2 can be provided to the calling terminal 2.

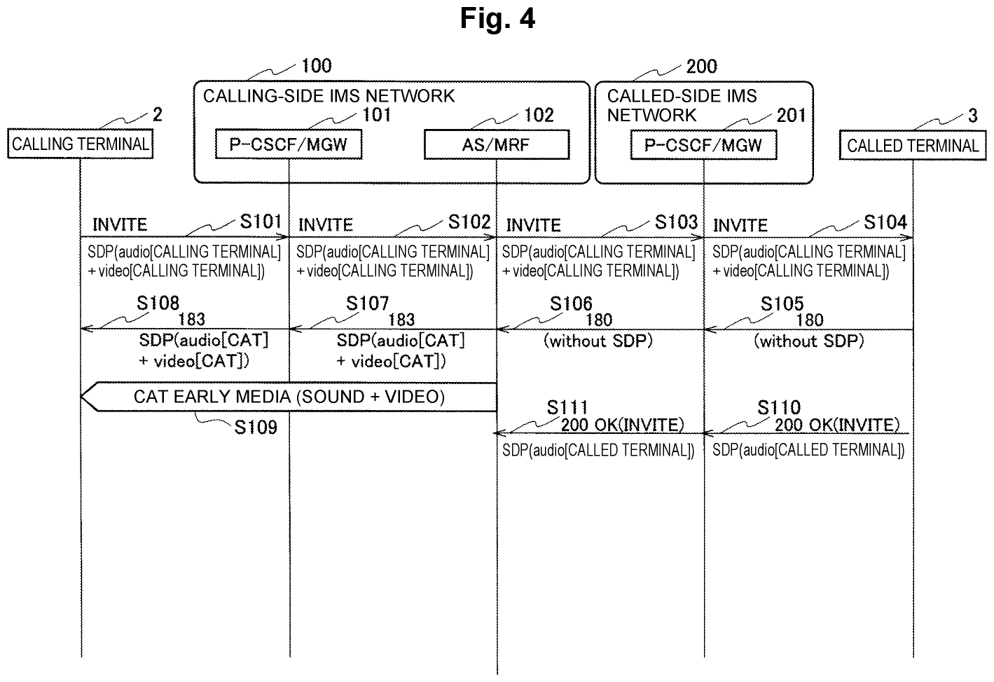

Processing sequences will be described with reference to FIGS. 4 to 6.

FIG. 4 shows a processing sequence during call connection.

First, in step S101, the calling terminal 2 transmits an INVITE message in which an audio component and a video component of the calling terminal 2 are set by SDP (Session Description Protocol) to the calling-side IMS network 100. The message is transmitted to the called terminal 3 via the P-CSCF/MGW function unit 101 and the AS/MRF function unit 102 of the calling-side IMS network and the P-CSCF/MGW function unit 201 of the called-side IMS network 200 in steps S102 to S104.

In step S105, the called terminal 3 transmits a 180 message without an SDP answer to the P-CSCF/MGW function unit 201 of the called-side IMS network 200. In step S106, the message is transmitted to the AS/MRF function unit 102 of the calling-side IMS network 100.

The AS/MRF function unit 102 transmits a 183 message in which an audio component and a video component of a CAT are set in an SDP answer to the P-CSCF/MGW function unit 101 in step S107. In step S108, the message is transmitted from the P-CSCF/MGW function unit 101 to the calling terminal 2.

For the above-described reason, in step S109, video and audio CAT early media is transmitted from the AS/MRF function unit 102 of the calling-side IMS network 100 to the calling terminal 2. The CAT early media is advertisement-related media set by the setup server 1. After that, in steps S110 and S111, a 200OK message in which an audio component of the called terminal 3 is set in an SDP answer is transmitted from the called terminal 3 to the AS/MRF function unit 102 of the calling-side IMS network 100 via the P-CSCF/MGW function unit 201 of the called-side IMS network 200.

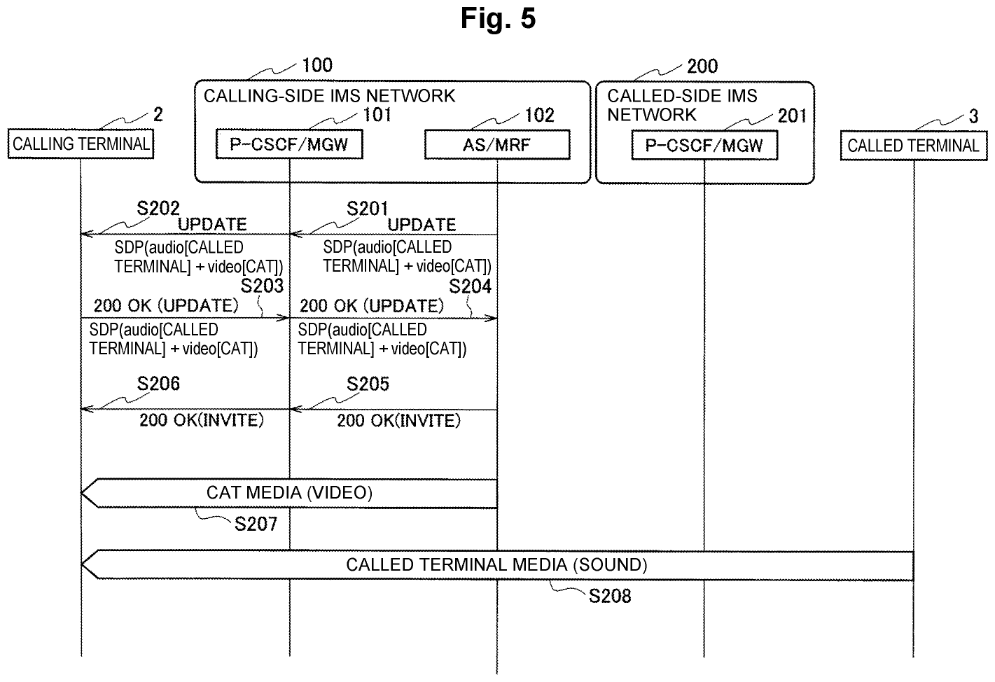

FIG. 5 shows a processing sequence during a call.

In step S201, the AS/MRF function unit 102 of the calling-side IMS network 100 transmits, to the P-CSCF/MGW function unit 101, an UPDATE message in which a video component of a CAT is set in an SDP answer received from the called terminal 3. In step S202, the message is transmitted from the P-CSCF/MGW function unit 101 to the calling terminal 2.

In steps S203 and S204, a 200OK message in which an audio component of the called terminal 3 and the video component of the CAT are set in an SDP answer is transmitted from the calling terminal 2 to the AS/MRF function unit 102 of the calling-side IMS network 100 via the P-CSCF/MGW function unit 101 of the calling-side IMS network 100. In steps S205 and S206, a 200OK message is transmitted from the AS/MRF function unit 102 of the calling-side IMS network 100 to the calling terminal 2 via the P-CSCF/MGW function unit 101.

For the above-described reason, in step S205, video CAT media is transmitted from the AS/MRF function unit 102 of the calling-side IMS network 100 to the calling terminal 2. The CAT media is advertisement-related media set by the setup server 1. In step S208, audio called terminal media is transmitted from the called terminal 3 to the calling terminal 2.

Control may be performed such that an advertisement transmitted as the CAT early media shown in FIG. 4 is continuous with an advertisement transmitted as the CAT media shown in FIG. 5.

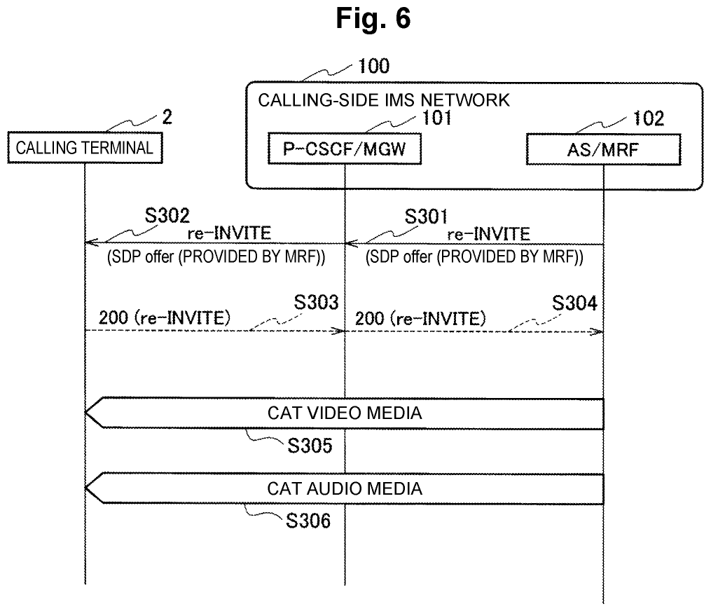

FIG. 6 shows a processing sequence after a call. A process of the calling-side IMS network 100 after a BYE message is transmitted from the called terminal 3 will be described.

When a BYE message is transmitted from the called-side IMS network 200, the AS/MRF function unit 102 of the calling-side IMS network 100 transmits a re-INVITE message in which media provided by the MRF function is set in an SDP offer to the calling terminal 2 via the P-CSCF/MGW function unit 101. The media provided by the MRF function is advertisement-related CAT media set by the setup server 1.

In steps S303 and S304, the calling terminal 2 transmits a 200OK message to the AS/MRF function unit 102 via the P-CSCF/MGW function unit 101. In steps S305 and S306, CAT video media is transmitted from the AS/MRF function unit 102 to the calling terminal 2, and CAT audio media is transmitted.

The above-described call system 5 according to the embodiment of the present invention is capable of displaying an advertisement on a terminal at the time of calling while viewing a screen of the terminal and measuring a display time period of the advertisement. This allows a telecommunications carrier to obtain an opportunity to provide an advertisement and a user of a terminal to obtain an opportunity to reduce a fee by viewing the advertisement.

(Modification)

The embodiment of the present invention has described a case where the calling-side IMS network 100 sets CAT media and charges the calling terminal 2. A modification will describe a call system 5a in which the called-side IMS network 200 sets CAT media and charges the calling terminal 2.

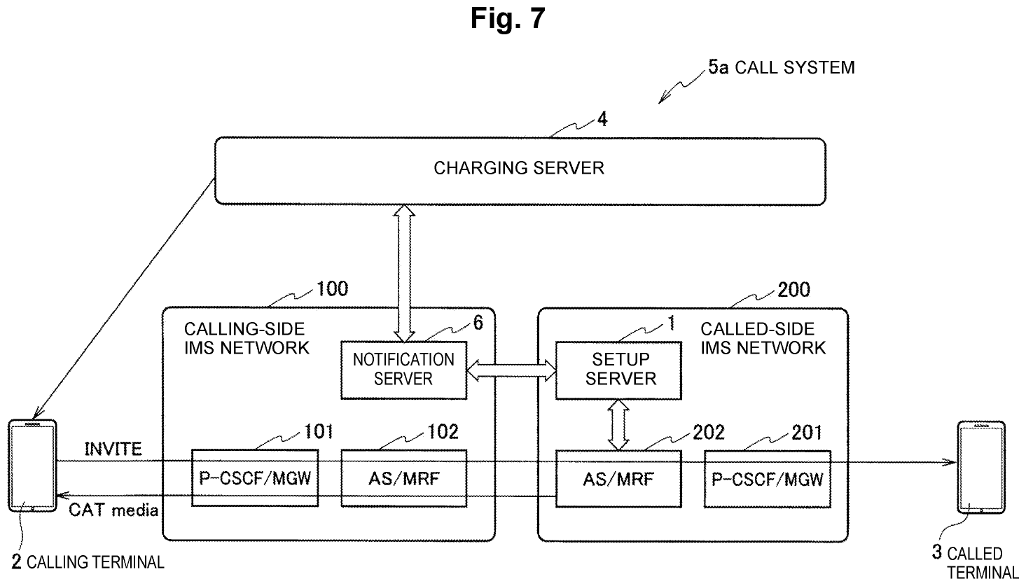

As shown in FIG. 7, in the modification, the setup server 1 is provided on the called-side IMS network 200. The setup server 1 sets CAT media in a signal addressed to the calling terminal 2 and measures a start time and an end time of the setting of the CAT media, in collaboration with the P-CSCF/MGW function unit 201 and the AS/MRF function unit 202 of the called-side IMS network 200. The setup server 1 transmits information on the times of the setting of the CAT media to a notification server 6 which is provided on the calling-side IMS network 100. The notification server 6 notifies the charging server 4 of the times notification of which is given from the setup server. Note that the setup server 1 provided on the called-side IMS network 200 may directly notify the charging server 4.

In the modification, the setup server 1 is capable of setting advertisement-related CAT media in a signal addressed to the calling terminal 2 and measuring times of the setting of the CAT media, as in the embodiment of the present invention. In a case where an instruction to stop playing the CAT media is input in the calling terminal 2, when the setup server 1 senses the instruction, the setup server 1 measures an end time of the setting of the CAT media.

Processing by the setup server 1 in the modification is the same as that in the embodiment. Sequential processes according to the modification may be obtained by reading the AS/MRF function unit 102 of the calling-side IMS network 100 in FIGS. 4 to 6 as the AS/MRF function unit 202 of the called-side IMS network 200.

The call system 5 according to the modification is capable of displaying an advertisement on a terminal at the time of calling while viewing a screen of the terminal and measuring a display time period of the advertisement, as in the embodiment. This allows a telecommunications carrier to obtain an opportunity to provide an advertisement and a user of a terminal to obtain an opportunity to reduce a fee by viewing the advertisement.

As the setup server 1 described above according to the present embodiment, for example, a general-purpose computer system including a CPU (Central Processing Unit or processor) 901, a memory 902, a storage 903 (an HDD (Hard Disk Drive) or an SSD (Solid State Drive)), a communication device 904, an input device 905, and an output device 906 is used. The CPU 901 is the processing device 20. The memory 902 and the storage 903 are the storage device 10. In the computer system, the CPU 901 executes a predetermined program loaded into the memory 902, thereby implementing the functions of the setup server 1.

Note that the setup server 1 may be implemented by one computer or may be implemented by a plurality of computers. Alternatively, the setup server 1 may be a virtual machine implemented on a computer.

The program of the setup server 1 can be stored in a computer-readable recording medium, such as an HDD, an SSD, a USB (Universal Serial Bus) memory, a CD (Compact Disc), or a DVD (Digital Versatile Disc), or can be distributed over a network.

Note that the present invention is not limited to the above-described embodiment, and various modifications can be made within the scope thereof.

### REFERENCE SIGNS LIST

1 Setup server
2 Calling terminal
3 Called terminal
4 Charging server
5 Call system
6 Notification server
10 Storage device
11 Advertisement media data
12 Measurement data
20 Processing device
21 Setup unit
22 Measurement unit
23 Transmission unit
100 Calling-side IMS network
101, 201 P-CSCF/MGW function unit
102, 202 AS/MRF function unit
200 Called-side IMS network
901 CPU
902 Memory
903 Storage
904 Communication device
905 Input device
906 Output device

1. A call system comprising a setup server provided on a communication network for controlling communication between a calling terminal and a called terminal and a charging server for charging the calling terminal,
wherein the setup server includes
a setup unit, including one or more processors, configured to set advertisement-related CAT media in a signal addressed to the calling terminal during a call between the calling terminal and the called terminal, and
a measurement unit, including one or more processors, configured to measure a start time and an end time of the setting of the CAT media in the signal addressed to the calling terminal,
the calling terminal includes a play unit, including one or more processors, configured to play the CAT media, and
the charging server includes a charge unit, including one or more processors, configured to charge the calling terminal on the basis of the measured times.

2. A call method used in a call system including a setup server provided on a communication network for controlling communication between a calling terminal and a called terminal and a charging server for charging the calling terminal, comprising:
setting, by the setup server, advertisement-related CAT media in a signal addressed to the calling terminal during a call between the calling terminal and the called terminal;
playing, by the calling terminal, the CAT media;
measuring, by the setup server, a start time and an end time of the setting of the CAT media in the signal addressed to the calling terminal; and
charging, by the charging server, the calling terminal on the basis of the measured times.

3. A setup server comprising:
a setup unit, including one or more processors, configured to set advertisement-related CAT media in a signal addressed to a calling terminal during a call between the calling terminal and a called terminal; and
a measurement unit, including one or more processors, configured to measure a start time and an end time of the setting of the CAT media in the signal addressed to the calling terminal.

4. The setup server according to claim 3, wherein
the setup unit is configured to set advertisement-related CAT early media in a signal addressed to the calling terminal during connection of a call from the calling terminal to the called terminal, and
the measurement unit is configured to measure a start time and an end time of the setting of the CAT early media in the signal addressed to the calling terminal.

5. The setup server according to claim 3, wherein the setup server is provided on a calling-side IMS network or a called-side IMS network.

6. The setup server according to claim 3, wherein
when an instruction to stop playing the CAT media is input in the calling terminal,
the measurement unit is configured to measure the end time.

7. The setup server according to claim 3, wherein
when the called terminal disconnects the call during the call between the calling terminal and the called terminal,
after reception of a 200OK message in response to a re-INVITE message transmitted to the calling terminal by an AS/MRF,
the setup unit is configured to set the CAT media in the signal addressed to the calling terminal.

8. A non-transitory computer readable medium storing a setup program for causing a computer to function as a setup server according to claim 3.

9. The call system according to claim 1, wherein
the setup unit of the setup server is configured to set advertisement-related CAT early media in a signal addressed to the calling terminal during connection of a call from the calling terminal to the called terminal, and
the measurement unit of the setup server is configured to measure a start time and an end time of the setting of the CAT early media in the signal addressed to the calling terminal.

10. The call system according to claim 1, wherein the setup server is provided on a calling-side IMS network or a called-side IMS network.

11. The call system according to claim 1, wherein
when an instruction to stop playing the CAT media is input in the calling terminal,
the measurement unit of the setup server is configured to measure the end time.

12. The call system according to claim 1, wherein
when the called terminal disconnects the call during the call between the calling terminal and the called terminal,
after reception of a 200OK message in response to a re-INVITE message transmitted to the calling terminal by an AS/MRF,
the setup unit of the setup server is configured to set the CAT media in the signal addressed to the calling terminal.

13. The call method according to claim 2, further comprising:
by the setup server, setting advertisement-related CAT early media in a signal addressed to the calling terminal during connection of a call from the calling terminal to the called terminal, and
by setup server, measuring a start time and an end time of the setting of the CAT early media in the signal addressed to the calling terminal.

14. The call method according to claim 2, wherein the setup server is provided on a calling-side IMS network or a called-side IMS network.

15. The call method according to claim 2, wherein
when an instruction to stop playing the CAT media is input in the calling terminal,
by the setup server, measuring the end time.

16. The call method according to claim 2, wherein
when the called terminal disconnects the call during the call between the calling terminal and the called terminal,
after reception of a 200OK message in response to a re-INVITE message transmitted to the calling terminal by an AS/MRF,
by the setup server is, setting the CAT media in the signal addressed to the calling terminal.
